(19) United States
(12) Patent Application Publication
(10) Pub. No.: US 2025/0228396 A1
(43) Pub. Date: Jul. 17, 2025

(54) Disposable Food Container Prepared with Inner Polypropylene Container and Paper Outer Shell

(71) Applicant: Dongil Chemical Co., Ltd., Cheonan-Si (KR)

(72) Inventor: Won Seok Oh, Gyeonggi-do (KR)

(73) Assignee: Dongil Chemical Co., Ltd., Cheonan-Si (KR)

(21) Appl. No.: 18/626,623

(22) Filed: Apr. 4, 2024

(30) Foreign Application Priority Data
Jan. 16, 2024 (KR) 10-2024-0006575

(51) Int. Cl. A47J 36/02; A47J 36/04; B65D 25/14; B65D 81/34

(52) U.S. Cl. CPC A47J 36/027; A47J 36/022; A47J 36/04; B65D 25/14; B65D 81/3453; B65D 2203/02; B65D 2581/3404; B65D 2581/3437

(57) ABSTRACT

A food container for a microwave oven consisting of a polypropylene inner container and a paper outer shell, wherein the polypropylene inner container is inserted into and adhered to the paper outer shell. The polypropylene inner shell container 31 is molded to a minimum thickness of about 0.1 to 0.3 mm to maintain heat resistance and formability. In order to be molded into such a thin container, polypropylene resin must be manufactured through vacuum molding or air press molding. The weight ratio of the polypropylene inner container and the paper outer shell is preferably in the range of 1:1 to 2. In the case of a 1-liter container, the weight of the container is preferably about 20 to 24 g, and the polypropylene inner container is preferably about 8 to 12 g, the paper outer shell preferably about 12 to 16 g.

### TECHNICAL FIELD

The present invention relates to a disposable food container for packaging instant foods such as various noodles such as ramen or udon, beef stew, and various stews such as kimchi stew. More specifically, the present invention relates to a disposable food container for cooking instant food packaged in a semi-cooked state by heating it in a microwave oven.

### BACKGROUND

Various types of noodles, such as cup ramen or cup udon, and various types of soups, such as meat stew or kimchi stew, are very common foods today. For most of these instant foods, boiling water heated to about 100° C. is poured on them, and they are consumed after waiting about 3 to 5 minutes. Some instant foods have been developed to be consumed after heating for a certain period of time using a microwave oven, but they have not yet become popular because it is not easy to develop food containers suitable for such heating conditions.

There is a big difference in the taste of instant foods packaged in disposable food containers between when cooked by pouring boiling water and when cooked using a microwave oven. Cooking by pouring boiling water has the effect of soaking the contents by hot water, but cooking using a microwave oven has the effect of boiling by directly applying heat, so the taste is much better than when cooking by pouring boiling water. If you can cook instant food in a microwave oven, you will be able to enjoy instant food that has the same level of taste as boiling it yourself using gas or electricity.

Most ready-to-eat food containers currently in the commercial distribution networks are manufactured using thick paper coated with polyethylene (PE) film. Containers made in this way do not leak even when boiling water is poured into them, so cooking with boiling water is possible. However, these containers cannot be used in cooking with a microwave oven. The container body made of paper coated with PE film has one joining part formed in the vertical direction, and another joining part is formed at the area where the container body and the bottom meet. When such a container is heated in a microwave oven, the water boils and the container is shaken with the contents, rupturing the PE film at the joining parts so that water may leak.

Some ready-to-eat food containers for use in a microwave oven are manufactured using polystyrene foam sheets with excellent heat resistance. Polystyrene (PS) foam sheets have excellent thermal insulation properties, but have poor heat resistance, so there are problems in using them in microwave ovens. Additionally, there is a problem of harmful substances being detected when boiling water is used or when using in a microwave oven.

Containers using polypropylene instead of polystyrene, which is harmful to the human body, were also developed. Korean Utility Model Registration Application Publication Nos. 2000-0007691 and 2000-0010571 disclose instant food container products having a plurality of protruding ribs on the surface of the container body to prevent the human body from directly contacting with the container body formed by injection molding of the polypropylene. However, since the containers are manufactured by injection molding, the containers are manufactured thick with a minimum thickness of 0.8 mm or more. Therefore, these containers were not commercialized.

Korean Patent Application Publication No. 2020-0002328 discloses a foam sheet made by foaming polyester resin with inorganic particles and a food container made of the sheet.

Korean Patent Application Publication No. 2002-0042464 discloses a polypropylene resin foam container for microwave cooking which does not deform during cooking n a microwave oven and has excellent heat resistance. This container is characterized by including a non-foam layer containing polypropylene resin and talc on at least one side of the polypropylene resin foam layer to solve the problem of the heated container being easily deformed when using a microwave oven.

The present inventor developed a disposable food container that can be used in a microwave oven made of a sheet of laminated polypropylene foam sheet and paper-based printing paper, and filed a patent application as Korean Patent Application No. 2020-0043117. However, this container requires foaming of polypropylene, and there are difficulties in the process of combining the foamed sheet and printing paper. The joining part of this container is weak because the side and bottom surfaces of the container are joined together from separated state. In other words, if this container is in a microwave, there is a very high possibility that the vulnerable joining part will rupture causing water to leak. Additionally, because the polypropylene sheet and paper are adhered, it is very difficult to separate them. Therefore, there is a serious problem for recycling. Due to these problems, this container was not commercialized.

To solve the above problems, the present inventor has developed a new disposable food container of the present invention that can be used in a microwave oven, is easy to manufacture and handle, and can be easily separated and collected to for recycling purposes.

### SUMMARY OF THE INVENTION

An objective of the present invention is to provide a disposable food container that can be safely used in a microwave oven.

Another objective of the present invention is to provide a disposable food container that can provide instant food with a taste equivalent to that of food cooked by directly boiling when cooking in a microwave oven.

Another objective of the present invention is to provide an environmentally friendly disposable food container that is composed of a paper outer shell and a polypropylene inner container, so that it can be easily separated and collected to increase the recycling rate.

Still another objective of the present invention is to provide a disposable food container that is composed of a paper outer shell and a polypropylene inner container which is easy to manufacture, thereby reducing manufacturing costs.

Another objective of the present invention is to provide a disposable food container that is composed of a paper outer shell and a polypropylene inner container and is easy to handle when used in a microwave oven.

The above and other objectives of the present invention can all be achieved by the present invention described in detail below.

The food container for a microwave oven according to the present invention is composed of a polypropylene inner container 31 and a paper outer shell 32, and has a structure in which the polypropylene inner container 31 is inserted into and adhered to the paper outer shell 32.

The polypropylene inner container 31 is molded to a minimum thickness of about 0.2 to 0.3 mm to maintain heat resistance and formability. In order to be molded into such a thin container, polypropylene resin must be manufactured through vacuum molding or air press molding, and injection molding is not a proper method of molding. Since this inner container is molded as one piece without any joining parts, there is no risk of it rupturing at any part when used in a microwave oven.

The paper outer shell 32 is manufactured for inserting and adhering the polypropylene inner shell container 31 therein. The paper outer shell 32 is printed with information necessary for product description, provides insulation, maintains the shape of the container, and also serves as a label.

The polypropylene inner container 31 is molded to a minimum thickness to provide heat resistance that can be used in a microwave oven, and the paper outer shell 32 is manufactured to a minimum thickness to provide formability and insulation. The weight ratio of the polypropylene inner container 31 and the paper outer shell 32 is preferably in the range of 1:1 to 2. In the case of a 1-liter container, the weight of the container is preferably about 20 to 24 g. In this case, the polypropylene inner container 31 is preferably about 8 to 12 g, and the paper outer shell 32 is preferably about 12 to 16 g. In this case, the thickness of the inner container 31 is in the range of about 0.1 to 0.3 mm. In a preferred embodiment, the inner container weighs 10 g and the outer shell weighs 12 g.

The polypropylene inner container 31 may have irregularities (wavy shapes) 311 formed in the vertical direction, which can improve the strength and insulation effect of the container.

An adhesive 312 is attached to the outside of the polypropylene inner container 31 at two to four points to adhere it to the paper outer shell 32. The inner container 31 and the outer shell 32 attached by the adhesive 312 can be easily separated and collected by separating them by hand.

A gift certificate can be attached or printed on the inside of the outer shell 32 so that the consumer can receive a free gift, thereby encouraging separate collection of the inner container 31 and the outer shell 32.

Instant food packaged in a food container according to the present invention can be consumed after heating in a microwave oven for 3 to 5 minutes depending on the contents. Instant foods heated in a microwave like this have the effect of cooking by directly boiling, so they can taste much better than instant foods cooked by pouring boiling water and soaking the contents.

The specific details of the present invention will be described below with reference to the attached drawings.

### Effects of the Invention

The present invention has the effect of providing a disposable instant food container that can be safely used with a microwave oven so that the food may provide the same level of taste as one boiled directly, can be easily separated and collected to increase the recycling rate, and can be easily manufactured to reduce manufacturing costs. The invention has the effect of providing a disposable food container.

### BRIEF DESCRIPTION OF THE DRAWINGS

FIG. 1(A) is a schematic perspective view illustrating a conventional disposable food container 10 in which the container body 11 is made of thick paper coated with PE film 111, and an outer shell (paper cover) 12 is inserted and adhered to the outside. FIG. 1(B) is an exploded perspective view of FIG. 1(A).

FIG. 2 is a schematic exploded perspective view of the food container 30 according to the present invention.

FIG. 3 is a schematic cross-sectional view taken along line A-A in FIG. 2.

FIG. 4 is a schematic exploded perspective view of another embodiment of the food container 30 according to the present invention.

### DETAILED DESCRIPTION OF THE EMBODIMENTS

The present invention relates to disposable food containers for packaging instant food, and to food containers that are used for cooking food by heating in a microwave oven.

Most ready-to-eat food containers currently in commercial distribution are made using thick paper coated with PE film and are made with a waterproof structure to prevent water from leaking.

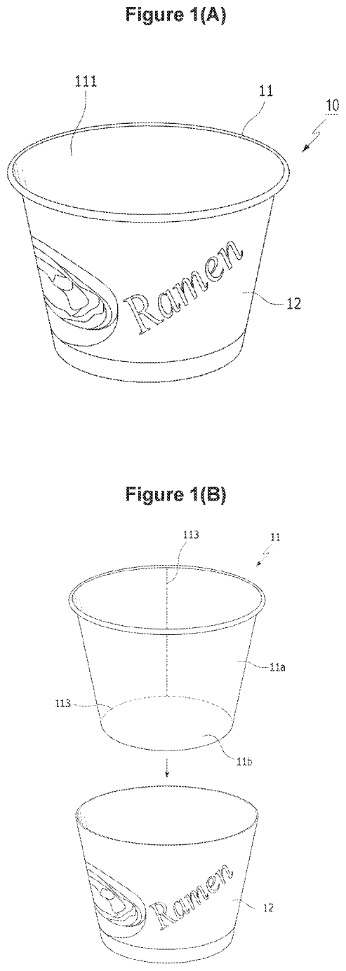

FIG. 1(A) a schematic perspective view of a conventional disposable food container 10 wherein container body 11 is made of thick paper coated with a transparent PE film 111, and an outer shell (paper cover) 12 inserted and adhered to the outside. FIG. 1(B) is an exploded perspective view of FIG. 1(A). Conventional containers manufactured in this way do not leak water even when boiling water is poured into them, so they can be used in cooking with boiling water. However, these containers cannot be used in cooking with a microwave oven. The container body 11 has one joining line 113 formed in the vertical direction, and another joining line 113 is formed at the area where the container side 11a and the bottom portion 11b are joined. When these containers are heated in a microwave oven, the water boils and fluctuates along with the contents, causing the polyethylene film 111 to rupture at the joining line 113 and the water may leak.

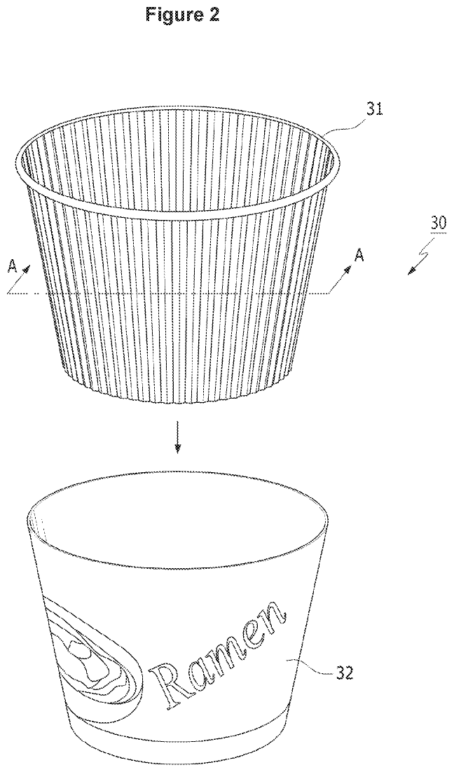

FIG. 2 is a schematic exploded perspective view of the food container 30 according to the present invention. The food container 30 for a microwave oven according to the present invention is composed of a polypropylene inner container 31 and a paper outer shell 32, and the polypropylene inner container 31 is inserted into and adhered to the paper outer shell 32.

The polypropylene inner shell container 31 is molded to a minimum thickness of about 0.1 to 0.3 mm to maintain heat resistance and formability. In order to mold to such a thin thickness, polypropylene resin must be manufactured by vacuum molding or air press molding, and injection molding is not a proper manufacturing method. Since this inner container is molded as one piece without joining parts, there is no risk of it rupturing at any part when used in a microwave oven. The polypropylene used can be a commercially available resin with a specific gravity of about 0.95.

The paper outer shell 32 is made of regular paper without a PE film coating, and the polypropylene inner shell container 31 is inserted and manufactured to adhere thereto. The paper shell 32 also serves as a label with printed information necessary for product description, including recipes. In other words, the paper shell 32 serves as a label while providing insulation and maintaining the shape of the container.

The polypropylene inner container 31 is molded to a minimum thickness to provide heat resistance so that it can be used in a microwave oven, and the paper outer container 32 is manufactured to a minimum thickness to provide formability and insulation. The weight ratio of the polypropylene inner container 31 and the paper outer shell 32 is preferably in the range of 1:1 to 2. In the case of a 1-liter container, the weight of the container is preferably about 20 to 24 g. In this case, the polypropylene inner container 31 is preferably about 8 to 12 g, and the paper outer shell 32 is preferably about 12 to 16 g. In this case, the thickness of the inner container 31 is in the range of about 0.1 to 0.3 mm. In a preferred embodiment, the inner container weighs 10 g and the outer shell weighs 12 g. If the volume of the container is larger or smaller than 1 liter, the weight of the inner container 31 and the outer shell 32 can be increased or decreased proportionally. This can be easily implemented by those skilled in the art to which the present invention pertains.

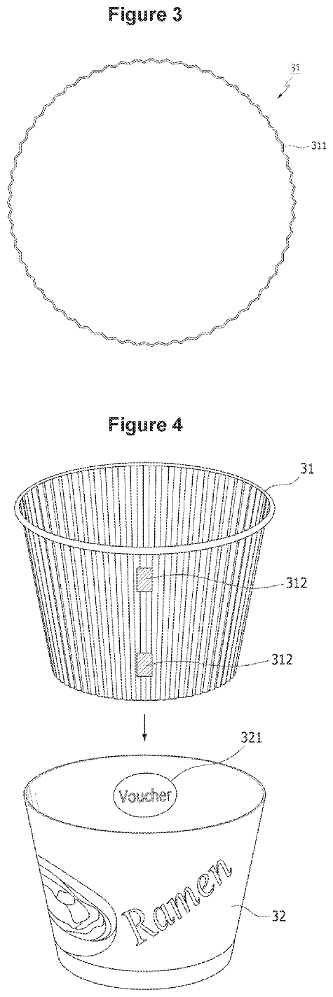

FIG. 3 is a schematic cross-sectional view taken along the line A-A in FIG. 2. An irregularity (wavy shape) 311 is formed in the longitudinal direction of the polypropylene inner shell container 31, thereby improving the strength and insulation effect of the container. The irregularities in FIG. 3 are just one example, and these irregularities can be easily modified by those skilled in the art.

FIG. 4 is a schematic exploded perspective view of another embodiment of the food container 30 according to the present invention. An adhesive 312 is attached to the outside of the polypropylene inner container 31 at two to four points to adhere it to the paper outer shell 32. A hot melt adhesive may be preferably used as the adhesive, and the process of inserting the inner container 31 into the outer shell 32 and adhering them to each other may be performed by an automated process. Such a kind of automated process is already a known in the art to which the present invention pertains.

The inner container 31 and the outer shell 32 attached by the adhesive 312 can be easily separated and collected by hand.

Separate collection of the inner container 31 and the outer shell 32 can be naturally induced by attaching or printing a gift certificate 321 to the inside of the outer shell 32 so that the consumer may receive a free gift.

Instant food packaged in a food container according to the present invention can be consumed after heating in a microwave oven for 3 to 5 minutes depending on the contents. Instant foods heated in a microwave oven like this have the effect of being directly boiled, so the taste is much better than instant foods cooked by pouring boiling water and soaking the contents.

The present invention will be embodied by the following examples, but the following examples are presented for illustrative purposes only and are not intended to limit in any way the scope of protection of the present invention.

### Example 1

A 1-liter inner container was formed by vacuum-forming 10 g of commercially available polypropylene resin with a specific gravity of 0.95. A 12 g outer shell was prepared for insert the inner container, and a food container with a total weight of 22 g was manufactured. The shape and strength of the container were sufficient. When the contents were placed and heated in a microwave for 7 minutes, there was no deformation and the heat resistance was sufficient.

### Example 2

The same procedure as Example 1 was applied except that 8 g of polypropylene resin was used. A food container with a total weight of 20 g was manufactured. Although the strength of the container was weaker than Example 1, it was within a range that could be used for a food container. When the contents were placed and heated in a microwave for 7 minutes, there was no deformation and the heat resistance was sufficient.

### Example 3

The same procedure as Example 1 was applied except that 12 g of polypropylene resin was used. A food container with a total weight of 24 g was manufactured. Although the strength of the container was stronger than Example 1, it was within a range suitable for use as a food container. When the contents were placed and heated in a microwave for 7 minutes, there was no deformation and the heat resistance was sufficient.

### Comparative Example 1

The same procedure as Example 1 was applied except that 13 g of polypropylene resin was used. A food container with a total weight of 25 g was manufactured. Although the strength of the container was stronger than that of Example 3, it was within the range suitable for use as a food container. When the contents were placed and heated in a microwave for 7 minutes, there was no deformation and the heat resistance was sufficient. However, since the container of Example 3 also had sufficient strength, using more than 12 g of polypropylene resin resulted in the use of unnecessary resin.

### Comparative Example 2

The same procedure as Example 1 was applied except that 6 g of polypropylene resin was used. A food container with a total weight of 18 g was manufactured. When the contents were placed and heated in a microwave for 7 minutes, there was no deformation and the heat resistance was sufficient. However, the strength of the container was weak and it was not suitable for use as a food container.

Simple modifications or changes to the present invention can be easily implemented by those skilled in the art, and all such modifications or changes can be considered to be within the scope of the present invention.

### EXPLANATION OF THE NUMERALS

10: food container
11: container body
11a: container side
11b: container bottom
12: outer shell (pater cover)
111: PE film
113: attachment line
31: PP inner container
32: paper outer shell (paper cover)
311: irregularities (wavy shapes)
312: adhesive
321: voucher

1. A food container for a microwave oven of comprising a polypropylene inner container and a paper outer shell, wherein the polypropylene inner container is inserted into and adhered to the paper outer shell.

2. The food container of claim 1, wherein a weight ratio the polypropylene inner container and the paper outer shell is in a range of 1:1 to 2, and wherein a thickness of the inner container is in a range of 0.1 to 0.3 mm.

3. The food container of claim 1, wherein the polypropylene inner container is molded by vacuum molding or air press molding.

4. The food container of claim 3, wherein, in the case of a 1-liter container, a weight ratio of the polypropylene inner container and the paper outer shell is in a range of 1:1 to 2, a weight of the polypropylene inner container is in a range of 8 to 12 g, and a weight of the paper outer shell in a range of 12 to 16 g.

5. The food container of claim 4, wherein the weight of the polypropylene inner container is 10 g, and the weight of the paper outer shell is 12 g.

6. The food container of claim 3, wherein the polypropylene inner container 31 has irregularities formed in a vertical direction thereof.

7. The food container of claim 3, wherein an adhesive is attached to an outside of the polypropylene inner container at two to four points to adhere it to the paper outer shell.

8. The food container of claim 3, wherein a gift certificate is attached or printed on an inside of the outer shell.

9. The food container of claim 2, wherein the polypropylene inner container is molded by vacuum molding or air press molding.

10. The food container of claim 1, wherein, in the case of a 1-liter container, a weight ratio of the polypropylene inner container and the paper outer shell is in a range of 1:1 to 2, a weight of the polypropylene inner container is in a range of 8 to 12 g, and a weight of the paper outer shell in a range of 12 to 16 g.

11. The food container of claim 10, wherein the weight of the polypropylene inner container is 10 g, and the weight of the paper outer shell is 12 g.

12. The food container of claim 1, wherein the polypropylene inner container has irregularities formed in a vertical direction thereof.

13. The food container of claim 1, wherein an adhesive is attached to an outside of the polypropylene inner container at two to four points to adhere it to the paper outer shell.

14. The food container of claim 1, wherein a gift certificate is attached or printed on an inside of the outer shell.
